(19) United States
(12) Patent Application Publication
(10) Pub. No.: US 2025/0193753 A1
(43) Pub. Date: Jun. 12, 2025

(54) METHODS AND APPARATUSES RELATING TO WIRELESS COMMUNICATION

(71) Applicant: Nokia Technologies Oy, Espoo (FI)

(72) Inventors: Navin HATHIRAMANI, Dallas, TX (US); Karri Markus RANTA-AHO, Espoo (FI)

(21) Appl. No.: 18/951,496

(22) Filed: Nov. 18, 2024

(30) Foreign Application Priority Data
Dec. 8, 2023 (FI) 20236350

(51) Int. Cl. H04W 36/08; H04W 36/00

(52) U.S. Cl. CPC H04W 36/08; H04W 36/0085

(57) ABSTRACT

Embodiments disclose configuring a terminal device to: use a first cell as a primary cell, PCell, based on a PCell configuration for the first cell, and a second cell as a secondary cell, SCell, based on an SCell configuration for the second cell; receive configuration information indicative of a post-swap PCell configuration for the second cell, a post-swap SCell configuration for the first cell, and at least one triggering condition for autonomous execution of a PCell swap procedure from the first cell to the second cell; in response to determining that a triggering condition of the at least one triggering condition is met, execute the PCell swap procedure by using the second cell as a PCell based on the post-swap PCell configuration for the second cell, and by using the first cell as an SCell based on the post-swap SCell configuration for the first cell.

### RELATED APPLICATION

This application claims the benefit of Finnish Application No. 20236350, filed on Dec. 8, 2023, which is incorporated herein by reference in its entirety.

### FIELD

This specification relates generally to wireless communication.

### BACKGROUND

Terminal devices, sometimes referred to as ‘user equipment’ (UE), can communicate wirelessly with other terminal devices and/or base stations. Such communication may facilitate a variety of tasks.

### SUMMARY

In a first aspect, this specification describes a terminal device comprising: means for configuring the terminal device to use a first cell of a telecommunication network as a primary cell, PCell, based on a PCell configuration for the first cell, and to use a second cell of the telecommunication network as a secondary cell, SCell, based on an SCell configuration for the second cell; means for receiving configuration information indicative of: a post-swap PCell configuration for the second cell, a post-swap SCell configuration for the first cell, and at least one triggering condition for autonomous execution by the terminal device of a PCell swap procedure from the first cell to the second cell; means for determining that a triggering condition of the at least one triggering condition is met; and means for, responsive to the determination that the triggering condition is met, executing the PCell swap procedure from the first cell to the second cell by: configuring the terminal device to use the second cell as a PCell based on the post-swap PCell configuration for the second cell, and configuring the terminal device to use the first cell as an SCell based on the post-swap SCell configuration for the first cell. In some examples, the post-swap PCell configuration for the second cell and the post-swap SCell configuration for the first cell are received prior to the triggering condition being met. In addition or alternatively, the at least one triggering condition may comprise at least one of the following: at least one measurement of signals received from the first cell being below a threshold; at least one measurement of signals received from the second cell being above a threshold; at least one measurement of signals received from the second cell being offset better than at least one measurement of signals received from the first cell; a transmit power for an uplink transmission from the terminal device to the first cell being above a transmit power threshold; or initiation, by the terminal device, of a particular service or service type. In some such examples, the at least one measurement of signals received from the first cell and the at least one measurement of signals received from the second cell may comprise reference signal received power, RSRP, measurements or reference signal received quality, RSRQ, measurements.

In some examples, the terminal device further comprises: means for configuring the terminal device to use a plurality of cells of the telecommunication network as SCells based on a plurality of SCell configurations for the respective plurality of cells, the plurality of cells including the second cell, wherein the received configuration information is further indicative of: a plurality of post-swap PCell configurations for the respective plurality of cells, and a plurality of triggering conditions for autonomous execution by the terminal device of PCell swap procedures from the first cell to the respective plurality of cells, wherein the terminal device further comprises: means for determining that a particular triggering condition of the plurality of triggering conditions is met; and means for, responsive to the determination that the particular triggering condition is met, executing a PCell swap procedure from the first cell to a particular cell of the plurality of cells which corresponds to the particular triggering condition by: configuring the terminal device to use the particular cell as a PCell based on a particular post-swap PCell configuration for the particular cell, the particular post-swap PCell configuration being part of the plurality of post-swap PCell configurations, and configuring the terminal device to use the first cell as an SCell based on the post-swap SCell configuration for the first cell. In some such examples, the received configuration information may be further indicative of priorities for the respective plurality of cells to be selected as a target PCell for autonomous execution by the terminal device of a PCell swap procedure from the first cell. In some examples, the post-swap SCell configuration for the first cell and the post-swap PCell configuration for the second cell comprise at least one of the following: a Physical Downlink Control Channel, PDCCH, monitoring configuration; a Physical Uplink Control Channel, PUCCH, transmit configuration; a measurement configuration for mobility measurements; a radio link monitoring configuration; a random-access configuration; a scheduling request configuration; or an uplink timing offset with respect to another cell of the telecommunication network. In addition or alternatively, the terminal device may further comprise: means for maintaining, after executing the PCell swap procedure from the first cell to the second cell, the PCell configuration for the first cell and the SCell configuration for the second cell; and means for, responsive to a further triggering condition being met, executing a further PCell swap procedure from the second cell back to the first cell by: configuring the terminal device to use the first cell as a PCell based on the maintained PCell configuration for the first cell, and configuring the terminal device to use the second cell as an SCell based on the maintained SCell configuration for the second cell. In some examples, the received configuration information may be further indicative of a release condition for autonomous execution by the terminal device of the PCell swap procedure from the first cell to the second cell, and the terminal device further comprises: means for determining that the release condition is met; and means for, responsive to the determination that the release condition is met, discarding the received configuration information for autonomous execution by the terminal device of the PCell swap procedure from the first cell to the second cell. In addition or alternatively, the terminal device may further comprise: means for, responsive to the terminal device being configured to use the second cell as a PCell, performing one of the following: performing a random access procedure to the second cell; transmitting a scheduling request to the second cell; or transmitting an additionally-configured Cell Radio Network temporary Identifier, C-RNTI, to the second cell. In some examples, the received configuration information is further indicative of an SCell release, suspension or deactivation condition for autonomous execution by the terminal device of an SCell release, suspension or deactivation procedure, and wherein the terminal device further comprises: means for determining that the SCell release, suspension or deactivation condition is met for a cell, which the terminal device is configured to use as an SCell; and means for, responsive to the determination that the SCell release, suspension or deactivation condition is met for the cell, configuring the terminal device to release, suspend or deactivate the cell.

In a second aspect, this specification describes a network node comprising: means for transmitting, to a terminal device configured to use a first cell of a telecommunication network as a primary cell, PCell, based on a PCell configuration for the first cell, the first cell being associated with the network node, and to use a second cell of the telecommunication network as a secondary cell, SCell, based on an SCell configuration for the second cell, configuration information indicative of: a post-swap PCell configuration for the second cell, a post-swap SCell configuration for the first cell, and at least one triggering condition for autonomous execution by the terminal device of a PCell swap procedure from the first cell to the second cell; means for receiving an indication that the PCell swap procedure from the first cell to the second cell has been autonomously executed by the terminal device responsive to a triggering condition of the at least one triggering condition being met; and means for configuring the first cell to operate as an SCell for the terminal device in accordance with the post-swap SCell configuration for the first cell. In some examples, the post-swap SCell configuration for the first cell and the post-swap PCell configuration for the second cell comprise at least one of the following: a Physical Downlink Control Channel, PDCCH, monitoring configuration; a Physical Uplink Control Channel, PUCCH, transmit configuration; a measurement configuration for mobility measurements; a radio link monitoring configuration; a random-access configuration; a scheduling request configuration; or an uplink timing offset with respect to another cell of the telecommunication network. In addition or alternatively, configuring the first cell to operate as an SCell for the terminal device in accordance with the post-swap SCell configuration for the first cell may comprise activating one or more network resources indicated by the post-swap SCell configuration for the first cell. In some examples, the indication is received from the second cell subsequent to the second cell being configured to operate as a PCell for the terminal device.

In a third aspect, this specification describes a network node comprising: means for configuring a second cell of a telecommunication network to operate as a PCell for a terminal device as part of a PCell swap procedure autonomously executed by the terminal device from a first cell of the telecommunication network to the second cell, the second cell being associated with the network node; and means for transmitting, to the first cell of the telecommunication network, an indication that the PCell swap procedure from the first cell to the second cell has been autonomously executed by the terminal device. In some examples, the network node further comprises: means for transmitting, to a third cell of the telecommunication network, another indication that the PCell swap procedure from the first cell to the second cell has been autonomously executed by the terminal device. In addition or alternatively, the second cell is configured to operate as a PCell for the terminal device as part of the PCell swap procedure responsive to the detection of one of: a random access procedure initiated by the terminal device with the second cell; a scheduling request received from the terminal device; or an additionally-configured Cell Radio Network temporary Identifier, C-RNTI, received from the terminal device.

In a fourth aspect, this specification describes an apparatus (e.g. a terminal device) comprising at least one processor and at least one memory storing instructions that, when executed by the at least one processor, cause the apparatus at least to perform: configuring the terminal device to use a first cell of a telecommunication network as a primary cell, PCell, based on a PCell configuration for the first cell, and to use a second cell of the telecommunication network as a secondary cell, SCell, based on an SCell configuration for the second cell; receiving configuration information indicative of: a post-swap PCell configuration for the second cell, a post-swap SCell configuration for the first cell, and at least one triggering condition for autonomous execution by the terminal device of a PCell swap procedure from the first cell to the second cell; determining that a triggering condition of the at least one triggering condition is met; and, responsive to the determination that the triggering condition is met, executing the PCell swap procedure from the first cell to the second cell by: configuring the terminal device to use the second cell as a PCell based on the post-swap PCell configuration for the second cell, and configuring the terminal device to use the first cell as an SCell based on the post-swap SCell configuration for the first cell. In some examples, the post-swap PCell configuration for the second cell and the post-swap SCell configuration for the first cell are received prior to the triggering condition being met. In addition or alternatively, the at least one triggering condition may comprise at least one of the following: at least one measurement of signals received from the first cell being below a threshold; at least one measurement of signals received from the second cell being above a threshold; at least one measurement of signals received from the second cell being offset better than at least one measurement of signals received from the first cell; a transmit power for an uplink transmission from the terminal device to the first cell being above a transmit power threshold; or initiation, by the terminal device, of a particular service or service type. In some such examples, the at least one measurement of signals received from the first cell and the at least one measurement of signals received from the second cell may comprise reference signal received power, RSRP, measurements or reference signal received quality, RSRQ, measurements.

In some examples, the instructions stored on the at least one memory of the apparatus of the fourth aspect, when executed by the at least one processor, may cause the apparatus at least to perform: configuring the terminal device to use a plurality of cells of the telecommunication network as SCells based on a plurality of SCell configurations for the respective plurality of cells, the plurality of cells including the second cell, wherein the received configuration information is further indicative of: a plurality of post-swap PCell configurations for the respective plurality of cells, and a plurality of triggering conditions for autonomous execution by the terminal device of PCell swap procedures from the first cell to the respective plurality of cells, the instructions stored on the at least one memory of the apparatus of the fourth aspect, when executed by the at least one processor, cause the apparatus at least to perform: determining that a particular triggering condition of the plurality of triggering conditions is met; and, responsive to the determination that the particular triggering condition is met, executing a PCell swap procedure from the first cell to a particular cell of the plurality of cells which corresponds to the particular triggering condition by: configuring the terminal device to use the particular cell as a PCell based on a particular post-swap PCell configuration for the particular cell, the particular post-swap PCell configuration being part of the plurality of post-swap PCell configurations, and configuring the terminal device to use the first cell as an SCell based on the post-swap SCell configuration for the first cell. In some such examples, the received configuration information may be further indicative of priorities for the respective plurality of cells to be selected as a target PCell for autonomous execution by the terminal device of a PCell swap procedure from the first cell. In some examples, the post-swap SCell configuration for the first cell and the post-swap PCell configuration for the second cell comprise at least one of the following: a Physical Downlink Control Channel, PDCCH, monitoring configuration; a Physical Uplink Control Channel, PUCCH, transmit configuration; a measurement configuration for mobility measurements; a radio link monitoring configuration; a random-access configuration; a scheduling request configuration; or an uplink timing offset with respect to another cell of the telecommunication network. In addition or alternatively, the instructions stored on the at least one memory of the apparatus of the fourth aspect, when executed by the at least one processor, may cause the apparatus at least to perform: maintaining, after executing the PCell swap procedure from the first cell to the second cell, the PCell configuration for the first cell and the SCell configuration for the second cell; and, responsive to a further triggering condition being met, executing a further PCell swap procedure from the second cell back to the first cell by: configuring the terminal device to use the first cell as a PCell based on the maintained PCell configuration for the first cell, and configuring the terminal device to use the second cell as an SCell based on the maintained SCell configuration for the second cell. In some examples, the received configuration information may be further indicative of a release condition for autonomous execution by the terminal device of the PCell swap procedure from the first cell to the second cell, and the instructions stored on the at least one memory of the apparatus of the fourth aspect, when executed by the at least one processor, may cause the apparatus at least to perform: determining that the release condition is met; and, responsive to the determination that the release condition is met, discarding the received configuration information for autonomous execution by the terminal device of the PCell swap procedure from the first cell to the second cell. In addition or alternatively, the instructions stored on the at least one memory of the apparatus of the fourth aspect, when executed by the at least one processor, may cause the apparatus at least to perform: responsive to the terminal device being configured to use the second cell as a PCell, performing one of the following: performing a random access procedure to the second cell; transmitting a scheduling request to the second cell; or transmitting an additionally-configured Cell Radio Network temporary Identifier, C-RNTI, to the second cell. In some examples, the received configuration information is further indicative of an SCell release, suspension or deactivation condition for autonomous execution by the terminal device of an SCell release, suspension or deactivation procedure, and the instructions stored on the at least one memory of the apparatus of the fourth aspect, when executed by the at least one processor, may cause the apparatus at least to perform: determining that the SCell release, suspension or deactivation condition is met for a cell, which the terminal device is configured to use as an SCell; and responsive to the determination that the SCell release, suspension or deactivation condition is met for the cell, configuring the terminal device to release, suspend or deactivate the cell.

In a fifth aspect, this specification describes an apparatus (e.g. a network node) comprising at least one processor and at least one memory storing instructions that, when executed by the at least one processor, cause the apparatus at least to perform: transmitting, to a terminal device configured to use a first cell of a telecommunication network as a primary cell, PCell, based on a PCell configuration for the first cell, the first cell being associated with the network node, and to use a second cell of the telecommunication network as a secondary cell, SCell, based on an SCell configuration for the second cell, configuration information indicative of: a post-swap PCell configuration for the second cell, a post-swap SCell configuration for the first cell, and at least one triggering condition for autonomous execution by the terminal device of a PCell swap procedure from the first cell to the second cell; receiving an indication that the PCell swap procedure from the first cell to the second cell has been autonomously executed by the terminal device responsive to a triggering condition of the at least one triggering condition being met; and configuring the first cell to operate as an SCell for the terminal device in accordance with the post-swap SCell configuration for the first cell. In some examples, the post-swap SCell configuration for the first cell and the post-swap PCell configuration for the second cell comprise at least one of the following: a Physical Downlink Control Channel, PDCCH, monitoring configuration; a Physical Uplink Control Channel, PUCCH, transmit configuration; a measurement configuration for mobility measurements; a radio link monitoring configuration; a random-access configuration; a scheduling request configuration; or an uplink timing offset with respect to another cell of the telecommunication network. In addition or alternatively, configuring the first cell to operate as an SCell for the terminal device in accordance with the post-swap SCell configuration for the first cell may comprise activating one or more network resources indicated by the post-swap SCell configuration for the first cell. In some examples, the indication is received from the second cell subsequent to the second cell being configured to operate as a PCell for the terminal device.

In a sixth aspect, this specification describes an apparatus (e.g. a terminal device) comprising at least one processor and at least one memory storing instructions that, when executed by the at least one processor, cause the apparatus at least to perform: configuring a second cell of a telecommunication network to operate as a PCell for a terminal device as part of a PCell swap procedure autonomously executed by the terminal device from a first cell of the telecommunication network to the second cell, the second cell being associated with the network node; and transmitting, to the first cell of the telecommunication network, an indication that the PCell swap procedure from the first cell to the second cell has been autonomously executed by the terminal device. In some examples, the instructions stored on the at least one memory of the apparatus of the sixth aspect, when executed by the at least one processor, may cause the apparatus at least to perform: transmitting, to a third cell of the telecommunication network, another indication that the PCell swap procedure from the first cell to the second cell has been autonomously executed by the terminal device. In addition or alternatively, the second cell is configured to operate as a PCell for the terminal device as part of the PCell swap procedure responsive to the detection of one of: a random access procedure initiated by the terminal device with the second cell; a scheduling request received from the terminal device; or an additionally-configured Cell Radio Network temporary Identifier, C-RNTI, received from the terminal device.

In a seventh aspect, this specification describes a method comprising: configuring a terminal device to use a first cell of a telecommunication network as a primary cell, PCell, based on a PCell configuration for the first cell, and to use a second cell of the telecommunication network as a secondary cell, SCell, based on an SCell configuration for the second cell; receiving configuration information indicative of: a post-swap PCell configuration for the second cell, a post-swap SCell configuration for the first cell, and at least one triggering condition for autonomous execution by the terminal device of a PCell swap procedure from the first cell to the second cell; determining that a triggering condition of the at least one triggering condition is met; and, responsive to the determination that the triggering condition is met, executing the PCell swap procedure from the first cell to the second cell by: configuring the terminal device to use the second cell as a PCell based on the post-swap PCell configuration for the second cell, and configuring the terminal device to use the first cell as an SCell based on the post-swap SCell configuration for the first cell. In some examples, the post-swap PCell configuration for the second cell and the post-swap SCell configuration for the first cell are received prior to the triggering condition being met. In addition or alternatively, the at least one triggering condition may comprise at least one of the following: at least one measurement of signals received from the first cell being below a threshold; at least one measurement of signals received from the second cell being above a threshold; at least one measurement of signals received from the second cell being offset better than at least one measurement of signals received from the first cell; a transmit power for an uplink transmission from the terminal device to the first cell being above a transmit power threshold; or initiation, by the terminal device, of a particular service or service type. In some such examples, the at least one measurement of signals received from the first cell and the at least one measurement of signals received from the second cell may comprise reference signal received power, RSRP, measurements or reference signal received quality, RSRQ, measurements.

In some examples, the method further comprises: configuring the terminal device to use a plurality of cells of the telecommunication network as SCells based on a plurality of SCell configurations for the respective plurality of cells, the plurality of cells including the second cell, wherein the received configuration information is further indicative of: a plurality of post-swap PCell configurations for the respective plurality of cells, and a plurality of triggering conditions for autonomous execution by the terminal device of PCell swap procedures from the first cell to the respective plurality of cells, the method further comprising: determining that a particular triggering condition of the plurality of triggering conditions is met; and, responsive to the determination that the particular triggering condition is met, executing a PCell swap procedure from the first cell to a particular cell of the plurality of cells which corresponds to the particular triggering condition by: configuring the terminal device to use the particular cell as a PCell based on a particular post-swap PCell configuration for the particular cell, the particular post-swap PCell configuration being part of the plurality of post-swap PCell configurations, and configuring the terminal device to use the first cell as an SCell based on the post-swap SCell configuration for the first cell. In some such examples, the received configuration information may be further indicative of priorities for the respective plurality of cells to be selected as a target PCell for autonomous execution by the terminal device of a PCell swap procedure from the first cell. In some examples, the post-swap SCell configuration for the first cell and the post-swap PCell configuration for the second cell comprise at least one of the following: a Physical Downlink Control Channel, PDCCH, monitoring configuration; a Physical Uplink Control Channel, PUCCH, transmit configuration; a measurement configuration for mobility measurements; a radio link monitoring configuration; a random-access configuration; a scheduling request configuration; or an uplink timing offset with respect to another cell of the telecommunication network. In addition or alternatively, the method may further comprise: maintaining, after executing the PCell swap procedure from the first cell to the second cell, the PCell configuration for the first cell and the SCell configuration for the second cell; and, responsive to a further triggering condition being met, executing a further PCell swap procedure from the second cell back to the first cell by: configuring the terminal device to use the first cell as a PCell based on the maintained PCell configuration for the first cell, and configuring the terminal device to use the second cell as an SCell based on the maintained SCell configuration for the second cell. In some examples, the received configuration information may be further indicative of a release condition for autonomous execution by the terminal device of the PCell swap procedure from the first cell to the second cell, and the method may further comprise: determining that the release condition is met; and, responsive to the determination that the release condition is met, discarding the received configuration information for autonomous execution by the terminal device of the PCell swap procedure from the first cell to the second cell. In addition or alternatively, the method may further comprise: responsive to the terminal device being configured to use the second cell as a PCell, performing one of the following: performing a random access procedure to the second cell; transmitting a scheduling request to the second cell; or transmitting an additionally-configured Cell Radio Network temporary Identifier, C-RNTI, to the second cell. In some examples, the received configuration information is further indicative of an SCell release, suspension or deactivation condition for autonomous execution by the terminal device of an SCell release, suspension or deactivation procedure, and the method may further comprise: determining that the SCell release, suspension or deactivation condition is met for a cell, which the terminal device is configured to use as an SCell; and responsive to the determination that the SCell release, suspension or deactivation condition is met for the cell, configuring the terminal device to release, suspend or deactivate the cell.

In a eighth aspect, this specification describes a method comprising: transmitting, to a terminal device configured to use a first cell of a telecommunication network as a primary cell, PCell, based on a PCell configuration for the first cell, the first cell being associated with the network node, and to use a second cell of the telecommunication network as a secondary cell, SCell, based on an SCell configuration for the second cell, configuration information indicative of: a post-swap PCell configuration for the second cell, a post-swap SCell configuration for the first cell, and at least one triggering condition for autonomous execution by the terminal device of a PCell swap procedure from the first cell to the second cell; receiving an indication that the PCell swap procedure from the first cell to the second cell has been autonomously executed by the terminal device responsive to a triggering condition of the at least one triggering condition being met; and configuring the first cell to operate as an SCell for the terminal device in accordance with the post-swap SCell configuration for the first cell. In some examples, the post-swap SCell configuration for the first cell and the post-swap PCell configuration for the second cell comprise at least one of the following: a Physical Downlink Control Channel, PDCCH, monitoring configuration; a Physical Uplink Control Channel, PUCCH, transmit configuration; a measurement configuration for mobility measurements; a radio link monitoring configuration; a random-access configuration; a scheduling request configuration; or an uplink timing offset with respect to another cell of the telecommunication network. In addition or alternatively, configuring the first cell to operate as an SCell for the terminal device in accordance with the post-swap SCell configuration for the first cell may comprise activating one or more network resources indicated by the post-swap SCell configuration for the first cell. In some examples, the indication is received from the second cell subsequent to the second cell being configured to operate as a PCell for the terminal device.

In a ninth aspect, this specification describes a method comprising: configuring a second cell of a telecommunication network to operate as a PCell for a terminal device as part of a PCell swap procedure autonomously executed by the terminal device from a first cell of the telecommunication network to the second cell, the second cell being associated with the network node; and transmitting, to the first cell of the telecommunication network, an indication that the PCell swap procedure from the first cell to the second cell has been autonomously executed by the terminal device. In some examples, the method may further comprise: transmitting, to a third cell of the telecommunication network, another indication that the PCell swap procedure from the first cell to the second cell has been autonomously executed by the terminal device. In addition or alternatively, the second cell is configured to operate as a PCell for the terminal device as part of the PCell swap procedure responsive to the detection of one of: a random access procedure initiated by the terminal device with the second cell; a scheduling request received from the terminal device; or an additionally-configured Cell Radio Network temporary Identifier, C-RNTI, received from the terminal device.

In a tenth aspect, this specification describes a non-transitory computer readable medium comprising program instructions stored thereon for performing at least any of the operations described above with reference to the seventh to ninth aspects.

### BRIEF DESCRIPTION OF THE FIGS

For better understanding of the present application, reference will now be made by way of example to the accompanying drawings in which:

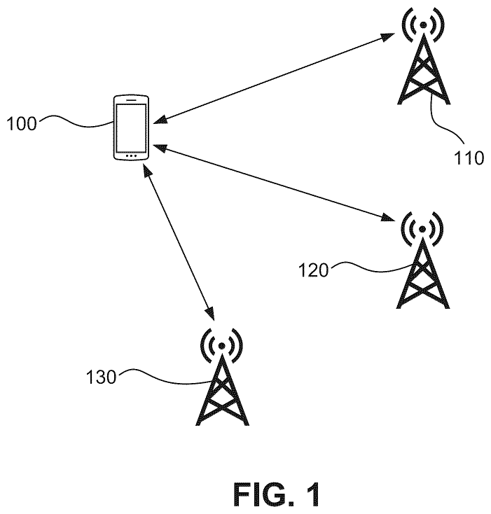

FIG. 1 is an example illustrating communications between a terminal device and a plurality of cells of a telecommunication network;

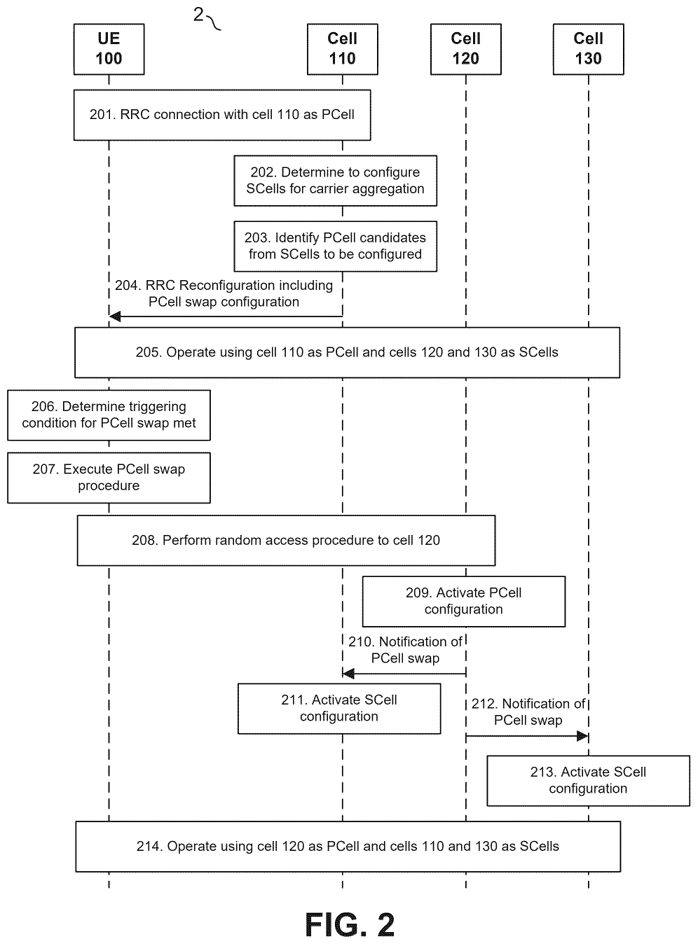

FIG. 2 is an example message flow sequence;

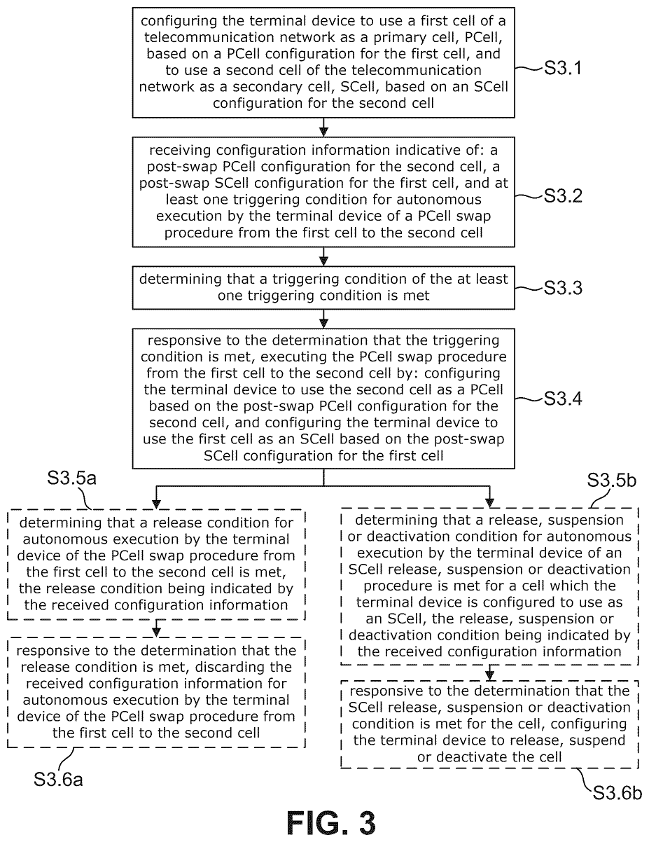

FIGS. 3 to 5 are flowcharts illustrating various operations which may be performed in accordance with examples described herein;

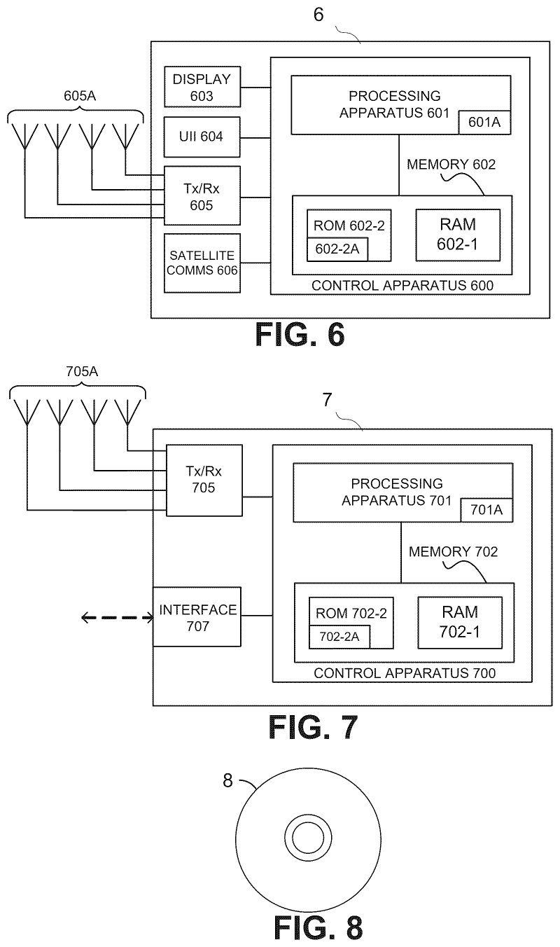

FIG. 6 is a schematic illustration of an example configuration of a terminal device which may be configured to perform various operations described with reference to FIGS. 1 to 5;

FIG. 7 is a schematic illustration of an example configuration of a base station which may be configured to perform various operations described with reference to FIGS. 1 to 5; and

FIG. 8 is an illustration of a computer-readable medium upon which computer readable code may be stored.

### DETAILED DESCRIPTION

In the description and drawings, like reference numerals refer to like elements throughout.

In modern telecommunication networks, carrier aggregation (CA) may be used to enable terminal devices to leverage capacity from multiple cells of the network, thereby improving data rates and/or network coverage. Specifically, rather than using a single serving cell, a set of serving cells is configured for the terminal device, including a ‘Primary Cell’ (PCell) and one or more ‘Secondary Cells’ (SCells). In this way, improved throughput for uplink (UL) and/or downlink (DL) communications may be achieved.

Put another way, in the carrier aggregation framework, carriers associated with multiple cells, which are typically (though not always) co-located, with at least partially overlapping coverage, are used to increase the bandwidth available to the terminal device for communicating with the network. As will be appreciated, carrier aggregation can be used with cells employing frequency-division duplexing (FDD) and/or time-division duplexing (TDD). However, terminal device capabilities may place a restriction on the particular carriers that can be aggregated.

Higher frequency bands typically have a greater available bandwidth than lower frequency bands, allowing for greater network throughput. However, higher transmission frequencies lead to greater signal attenuation with distance, thereby reducing cell coverage. New high-frequency bands (e.g. above 3 GHz) are deployed in modern telecommunication networks to increase network capacity, but are unable to attain the coverage footprint achieved by lower frequency bands (e.g. 800 MHz) when deployed on the same base station grid as lower frequency bands.

As such, when carrier aggregation is used to aggregate carrier components (CCs) from both high and low frequency bands, it is necessary to balance the requirements of both network capacity and robustness for both UL and DL transmissions. On the one hand, the cell corresponding to the lower frequency band could be used as the PCell, ensuring network robustness, and the cell corresponding to the higher frequency band could be used as an SCell, giving additional capacity. However, in this case, the limited capacity of the lower frequency band may lead to a bottleneck, particularly in the uplink if uplink CA is not employed, or in the downlink if cross-carrier scheduling from Physical DL Control Channel (PDCCH) is employed. Moreover, using the lower band cell as the PCell would leave the uplink capacity of the higher frequency SCell under-utilised. Even if uplink CA is used, the Physical UL Control Channel (PUCCH) is still mapped to the PCell. As such, unless the higher capacity cell is configured to act as the PCell, the lower-capacity cell's UL is loaded by the PUCCH of the UEs, even if the Physical UL Shared Channel (PUSCH) of the UEs can be scheduled on the higher-capacity cell when the UEs are experiencing good coverage.

Put another way, lower frequency carriers can reach a greater number of UEs (i.e. terminal devices) due to their signal propagation characteristics, but have a lower capacity than higher frequency carriers. In order to distribute the uplink load for UEs between the two carriers, one approach is to place the uplink (or uplink control if UL CA is used) for as many UEs as possible on the higher frequency carrier (i.e. make the cell corresponding to the higher frequency carrier the PCell) and to place uplink for any remaining UEs on the lower frequency carrier as the PCell. Since the higher frequency carriers typically have a greater bandwidth and thus have more capacity than the lower band carriers, it is beneficial to try to steer the PCell for UEs onto the higher frequency carrier where possible.

One solution to this problem is to configure cells corresponding to higher bands as PCells and cells corresponding to lower bands as SCells, with the lower band cells being used as a fall-back to ensure robustness. However, if radio measurements indicate that the PCell should be changed to another cell, current procedures involve unacceptable latency, which may be perceived by users of terminal devices.

It may therefore be beneficial to provide a low latency PCell swap framework which allows terminal devices employing carrier aggregation to better leverage the capacity of high frequency bands and the robustness of low frequency bands. Implementations of the technology described herein may provide such a low latency PCell swap framework.

Various aspects of the technology described herein relate to a terminal device comprising: means for configuring the terminal device to use a first cell of a telecommunication network as a primary cell, PCell, based on a PCell configuration for the first cell, and to use a second cell of the telecommunication network as a secondary cell, SCell, based on an SCell configuration for the second cell; means for receiving configuration information indicative of: a post-swap PCell configuration for the second cell, a post-swap SCell configuration for the first cell, and at least one triggering condition for autonomous execution by the terminal device of a PCell swap procedure from the first cell to the second cell; means for determining that a triggering condition of the at least one triggering condition is met; and means for, responsive to the determination that the triggering condition is met, executing the PCell swap procedure from the first cell to the second cell by: configuring the terminal device to use the second cell as a PCell based on the post-swap PCell configuration for the second cell, and configuring the terminal device to use the first cell as an SCell based on the post-swap SCell configuration for the first cell. Other aspects of the technology described herein relate to a network node comprising: means for transmitting, to a terminal device configured to use a first cell of a telecommunication network as a primary cell, PCell, based on a PCell configuration for the first cell, the first cell being associated with the network node, and to use a second cell of the telecommunication network as a secondary cell, SCell, based on an SCell configuration for the second cell, configuration information indicative of: a post-swap PCell configuration for the second cell, a post-swap SCell configuration for the first cell, and at least one triggering condition for autonomous execution by the terminal device of a PCell swap procedure from the first cell to the second cell; means for receiving an indication that the PCell swap procedure from the first cell to the second cell has been autonomously executed by the terminal device responsive to a triggering condition of the at least one triggering condition being met; and means for configuring the first cell to operate as an SCell for the terminal device in accordance with the post-swap SCell configuration for the first cell. Other aspects of the technology described herein relate to a network node comprising: means for configuring a second cell of a telecommunication network to operate as a PCell for a terminal device as part of a PCell swap procedure autonomously executed by the terminal device from a first cell of the telecommunication network to the second cell, the second cell being associated with the network node; and means for transmitting, to the first cell of the telecommunication network, an indication that the PCell swap procedure from the first cell to the second cell has been autonomously executed by the terminal device.

As explained below in greater detail with respect to FIG. 1, various implementations of the technology described herein may provide a lightweight framework which allows configured cells within a CA combination to change roles between PCell and SCell. In this way, the gNB may more efficiently employ its resources for each carrier component. For instance, the gNB may be able to reserve low frequency bands, which may be more robust, for voice services, thereby reducing the likelihood of dropped calls. Moreover, various implementations of the technology described herein build upon the existing conditional handover (CHO) framework by incorporating elements specific to the carrier aggregation context.

In some examples, the term ‘terminal device’ or ‘user equipment’ may refer to any device employed by a user to communicate. Whilst the terminal device of FIG. 1 is depicted as a mobile telephone or ‘smartphone’, it will of course be appreciated that terminal devices may comprise various other devices, including, but not limited to laptops, smartwatches, tablet computers and vehicle-based terminal devices, such as those mounted on cars, buses, uncrewed aerial vehicles (UAVs), aeroplanes, trains, or boats. Alternatively, mobile terminal devices may be carried by a user, or worn on their person.

In some examples, the PCell, or primary serving cell, may refer to the cell with which the terminal device would typically perform the random access (RA) procedure, radio link monitoring (RLM), handover procedures and PUCCH transmission. In some examples, the terminal device may establish whether the connection with the network is lost if the RLM measurements performed based on the PCell fulfil an established criterion. In the event of a connection loss, the terminal device can begin a re-establishment procedure. While RLM measurements may also be performed for the SCell, radio link failure in this instance (i.e. as indicated by SCell RLM measurements) does not indicate a total loss of connection to the network as the terminal device is still connected to the PCell. As such, a re-establishment procedure may not be required.

As explained above, the SCell, or secondary serving cell, may support the PCell to provide improved coverage and/or capacity. In some examples, the activation and deactivation of SCells is performed using Medium Access Control (MAC) signalling, rather than Radio Resource Control (RRC) signalling. By using MAC signalling, the network can quickly change the activation/deactivation status of the SCells in accordance with data activity, which improves terminal device battery consumption. Furthermore, the indication of SCell dormancy and non-dormancy can be realized via the detection by the UE of a Downlink Control Information (DCI) on the Physical Downlink Control Channel (PDCCH).

In some examples, the term ‘serving cell’ may refer to the PCell and SCell collectively. In other examples, such as those in which no SCells are configured, the term ‘serving cell’ may just refer to the PCell.

As will be appreciated, in order to use a given cell as a PCell or SCell, both the cell in question and the associated terminal devices must be configured appropriately. The contents of a PCell configuration or SCell configuration for use in configuring a terminal device are described below with reference to FIGS. 1 and 2.

Various methods and apparatuses are described in detail below, by way of example only, in the context of a cellular network, such as an Evolved Universal Terrestrial Radio Access (E-UTRA) network or a 5G network. However, it will be appreciated that the techniques may be applicable with communications networks of other types (e.g. but not limited to other types of cellular network). Cellular networks may comprise one or more base stations, sometimes referred to as transmit-receive points (TRPs) or access points (e.g. but not limited to gNBs and/or eNBs). Whilst only three base stations (corresponding to cells 110, 120 and 130) are depicted in FIG. 1, a radio access network (RAN, NG-RAN) may typically comprise thousands of such base stations. Together, the base stations may provide cellular network coverage to one or more terminal devices over a wide geographical area.

Although by no means limited to such an implementation, the examples of the technology described herein may readily be integrated into any New Radio (NR) terminal device or base station which utilises carrier aggregation. Furthermore, examples of the technology described herein may be compliant with future mobility enhancements which are expected to be specified in 3GPP Release 19 or beyond (6G).

In some implementations and, for instance, depending on the characteristics of the

cellular network, the base stations and terminal devices within the network may be configured to communicate with one another, for instance, using an OFDM-based communication scheme, such as orthogonal frequency-division multiple access (OFDMA), single carrier frequency-division multiple access (SC-FDMA), and/or cyclic prefix orthogonal frequency-division multiple access (CP-OFDMA).

FIG. 1 depicts a terminal device 100 together with cells 110, 120 and 130 of a telecommunication network. These cells may belong to the same gNB or different gNBs. In the example of FIG. 1, terminal device 100 is configured to use a first cell 110 as a PCell, based on a PCell configuration for the first cell 110, and to use a second cell 120 as an SCell, based on an SCell configuration for the second cell 120. In addition to the second cell 120, terminal device 100 may be further configured to use one or more additional cells as SCells, such as third cell 130, based on one or more respective SCell configurations for those additional cells. A PCell/SCell configuration for a given cell may include various parameters for use by the terminal device 100 in operating using the given cell as a PCell/SCell.

Terminal device 100 receives configuration information indicative of: a post-swap PCell configuration for the second cell 120, a post-swap SCell configuration for the first cell 110, and at least one triggering condition for autonomous execution by the terminal device 100 of a PCell swap procedure from the first cell 110 to the second cell 120. Responsive to determining that a triggering condition of the at least one triggering condition is met, terminal device 100 executes the PCell swap procedure from the first cell 110 to the second cell 120 by: configuring the terminal device 100 to use the second cell 120 as a PCell based on the post-swap PCell configuration for the second cell 120, and configuring the terminal device 100 to use the first cell 110 as an SCell based on the post-swap SCell configuration for the first cell 110.

In other words, the terminal device 100 is configured by the network to autonomously execute a conditional PCell-SCell swap procedure in which the roles of a first cell 110, which, pre-swap, is configured to operate as a PCell for the terminal device 100, and a second cell 120, which, pre-swap, is configured to operate as an SCell for the terminal device 100, are reversed. After the swap, the first cell 110 is configured to operate as an SCell for the terminal device 100, and the second cell 120 is configured to operate as a PCell for the terminal device 100. As will be appreciated, the second cell may be any of the SCells of the terminal device 100 that are determined, by the network, to be suitable to act as a PCell. The terminal device 100 monitors at least one triggering condition for the swap, and executes the PCell-SCell swap responsive to at least one of the monitored triggering condition(s) being satisfied.

As will be appreciated, the autonomous PCell swap may be configured at the terminal device 100 either together with or separately from the carrier aggregation. In the former case, the received configuration information is further indicative of an SCell configuration for the second cell 120 and any other cells identified by the network for use as an SCell. In the latter case, the configuration information is received subsequent to the second cell 120 being configured as an SCell.

In some examples, the post-swap SCell configuration for the first cell 110 and the post-swap PCell configuration for the second cell 120 comprises one or a combination of the following: a Physical Downlink Control Channel, PDCCH, monitoring configuration; a Physical Uplink Control Channel, PUCCH, transmit configuration; a measurement configuration for mobility measurements; a radio link monitoring configuration; a random-access configuration; a scheduling request configuration; an additionally-configured cell radio identifier to be used for indicating autonomous execution of a PCell swap procedure by the terminal device 100; or an uplink timing offset with respect to another cell of the telecommunication network. Other components of a PCell or SCell configuration for use by either a terminal device or a cell in facilitating cellular communication between the terminal device and the cell will be apparent to the skilled person.

In some examples, the at least one triggering condition comprises at least one of the following: at least one measurement of signals received from the first cell being below a threshold; at least one measurement of signals received from the second cell being above a threshold; at least one measurement of signals received from the second cell being offset better than at least one measurement of signals received from the first cell. In some such examples, the at least one measurement of signals received from the first cell and the at least one measurement of signals received from the second cell comprise reference signal received power, RSRP, measurements or reference signal received quality, RSRQ, measurements. In addition or alternatively, the triggering condition(s) may comprise a transmit power for an uplink transmission from the terminal device to the first cell being above a transmit power threshold.

In addition or alternatively, the at least one triggering condition may comprise initiation, by the terminal device 100, of a new service to be provided through the second cell. Put another way, when a new service is initiated at the terminal device 100, it may be determined that a different PCell-SCell configuration is appropriate to ensure the adequate network coverage and capacity is provided for the new service. As explained above, cells corresponding to lower frequency bands provide better coverage, but higher frequency bands provide larger bandwidths and throughputs, and lower latency. Accordingly, lower bands are typically preferred to act as the PCell for services where high reliability is required to reduce the occurrences of mobility events. Such services may then be said to be associated with cells corresponding to lower band carriers. On the other hand, services (or types of service) requiring higher bitrates and lower latency may be associated with cells corresponding to higher band carriers. Example services include voice over 5G (VoNR) or eXtended reality (XR), which can require high bit rates and low latency, and so may prefer higher frequency band cells to act as the PCell.

Put another way, network operators may have preferences as to which layers or cells are used to provide certain services.

Another example of a service which, when initiated at the terminal device, may serve as a triggering condition for a PCell swap is a location-based service. In this case, it may be determined that the current PCell does not support the particular positioning methods required for execution of this service, or that the terminal device does not support the positioning methods used by the current PCell (e.g. inter-frequency positioning methods). The PCell swap may then allow a different cell, which has the capabilities required for providing the location-based service to the terminal device, to act as the PCell. For example, services requiring high location accuracy may be targeted to layers in which Positioning Reference Symbols (PRS) can be (or are) activated so as to avoid the terminal device having to perform inter-frequency measurements of the PRS. Other example services which may require a PCell swap procedure to be initiated will be apparent to the skilled person.

Other triggering conditions for the PCell-SCell swap may also be used by the terminal device 100 to trigger execution of the PCell swap procedure. For instance, the procedure may be triggered when a Channel Quality Indicator (CQI) for the PCell falls below a threshold or stays below the threshold for a certain number of measurement reports. Put another way, a terminal device reporting a low CQI value for its active PCell may be a trigger condition for a PCell swap.

In addition or alternatively, the procedure may be executed responsive to a PUCCH and/or PUSCH transmit power meeting or exceeding a threshold indicated by the configuration information. In addition or alternatively, the procedure may be triggered by a measurement (e.g. an RSRP or RSRQ measurement) for the second cell being greater than a corresponding measurement for the first cell by at least a predetermined threshold indicated by the configuration information. As will be appreciated, if the PUCCH link is the weakest link in the link budget, then this may impact all other transmissions since PUCCH transmissions can be employed to provide channel state information, hybrid automatic repeat request (HARQ) feedback, and can also be employed for PCell UL timing measurements for the terminal device. If the terminal device is configured for a max PUCCH or PUSCH transmission power, it could determine if there is a better PCell using RSRP measurements for a more spectrally efficient use of the available resources.

Various other triggering conditions will be apparent to the skilled person.

As described above, responsive to the determination that the triggering condition is met, terminal device 100 executes the PCell swap procedure from the first cell 110 to the second cell 120 by: configuring the terminal device 100 to use the second cell 120 as a PCell based on the post-swap PCell configuration for the second cell 120, and configuring the terminal device to use the first cell 110 as an SCell based on the post-swap SCell configuration for the first cell 110.

In order to use the second cell 120 as a PCell, the terminal device 100 may acquire UL timing information from the new PCell (i.e. the second cell 120) according to various procedures that will be apparent to the skilled person. For instance, the terminal device 100 may perform a random access procedure to the second cell 120, if required. In some instances the terminal device 100 may be provided with (e.g. in the received configuration information) an uplink timing offset of the second cell 120 with respect to another cell, for instance the first cell 110, and hence a random access procedure may not be required. In another embodiment, the terminal device 100 may be informed whether a random access procedure is required to obtain uplink synchronization, or whether the current UL timing offset shall be maintained for second cell 120 as a PCell. This latter case could be employed, for example, when the first cell 110 (PCell) and the second cell 120 (SCell) are collocated cells and are intra-band.

Upon completion of the PCell swap procedure, the new PCell and/or the old PCell (which is now operating an SCell) may notify other cells of the network the swap has been performed. For instance, such information may be used by other SCells of the network in reconfiguring the PDCCH monitoring or the state (dormant/non-dormant, active/deactivated, released, etc) of an SCell based on the configuration provided to the terminal device 100. Put another way, an indication that the PCell swap procedure has been autonomously executed by the terminal device 100 from the first cell 110 to the second cell 120 may be transmitted, to one or more other cells of the network.

It will be appreciated that some data transmitted by the terminal device 100 to the first cell 110 (i.e. the old PCell) may be received when the first cell 110 is no longer acting as a PCell. As such, these data may not be acknowledged yet. In examples in which the old PCell, now acting as an SCell, does not perform data forwarding to any other cell, any unacknowledged data may be retransmitted as required. Downlink data in the buffers of cells that are active after the swap procedure need not be discarded.

In some examples, the conditional PCell-SCell swap configuration is ‘pervasive’. Put another way, after execution of the PCell-SCell swap procedure by the terminal device 100, the configuration (i.e. the received configuration information) may be maintained by the terminal device 100 and the serving cells 110 and 120, allowing for additional PCell-SCell swaps to be performed without requiring additional signalling to reconfigure the autonomous swap procedure. Put yet another way, the terminal device 100 may maintain, after executing the PCell swap procedure from the first cell 110 to the second cell 120, the initial PCell configuration for the first cell 110 and the initial SCell configuration for the second cell 120. Responsive to a further triggering condition being met, the terminal device 100 may execute a further PCell swap procedure from the second cell 120 back to the first cell 110 by: configuring the terminal device to use the first cell 110 again as a PCell based on the maintained PCell configuration for the first cell 110, and configuring the terminal device to use the second cell 120 again as an SCell based on the maintained SCell configuration for the second cell 120. In some examples, the further triggering condition may be configured along with the original PCell swap, thereby saving on signalling. In other examples, a separate message including the further triggering condition may be transmitted to the terminal device 100 by the network (e.g. via the PCell).

As mentioned above, in the context of carrier aggregation, a plurality of SCells may be used to provide service to the terminal device 100. For instance, terminal device 100 may be configured to use both the second cell, cell 120, and a third cell, cell 130, as SCells. Accordingly, multiple candidate PCells may be identified in the received configuration information, along with corresponding PCell configurations for those cells and at least one respective trigger condition for triggering a PCell swap procedure to each of those cells. The terminal device may monitor all of the received triggering conditions and, responsive to one of those conditions being satisfied, the PCell swap may be performed from the first cell 110 to the cell corresponding to the satisfied trigger condition.

Where triggering conditions for multiple cells are satisfied at once, PCell swaps to particular cells may be prioritised based on the type of the triggering condition. For instance, the target PCell for the swap may be different if the swap is triggered due to the UE initiating a VoNR or XR session as opposed to if the swap is initiated due to coverage issues. Put another way, the received configuration information may be further indicative of priorities for the candidate PCells cells to be selected as a target PCell for autonomous execution by the terminal device 100 of a PCell swap procedure from the first cell 110 to the target PCell. In some examples, the network (e.g. at the gNB) can establish a priority governing the order in which the terminal device 100 attempts to swap to each of the candidate SCells.

In addition or alternatively, a criterion for releasing the PCell-SCell swap configuration may be configured at the terminal device. Responsive to the criterion being met, the terminal device may discard the received configuration information for autonomous execution by the terminal device of the PCell swap procedure from the first cell 110 to the second cell 120. As will be appreciated, in some examples, the PCell swap configuration may be released without performance of the PCell swap procedure. Alternatively, the PCell swap configuration may be released after performance of the PCell swap procedure.

For instance, the criterion for releasing the PCell-SCell swap configuration may comprise initiating a service with which the current configuration of CA and PCell swaps is not desired to be used simultaneously. As will be appreciated, some combinations may lead to poor reliability or adversely affect terminal device battery life. For instance, if the terminal device triggers a voice call, the gNB may dictate that any PCell changes should follow a different PCell swap configuration (e.g. with different triggering conditions) to maximize network robustness. In such cases, it may therefore be desirable to release the PCell swap configuration, possibly after performing an initial PCell swap which allows the voice call session to be established on an adequate, though perhaps sub-optimal, cell.

In addition or alternatively, the received configuration information may be further indicative of an SCell release, suspension or deactivation condition for autonomous execution by the terminal device 100 of an SCell release, suspension or deactivation procedure. Responsive to determining that the condition is met for a given SCell, the terminal device 100 may be configured to release, suspend or deactivate the given SCell. For instance, the condition may comprise a certain CA combination not being supported by the terminal device. That is to say, a given cell, when acting as PCell, may not support certain SCells. Alternatively, the condition may comprise a certain CA combination leading to intermodulation distortion. In other examples, these procedures may be triggered by network signalling. For instance, SCell release may be an L3 (RRC) procedure, SCell deactivation may be an L2 (MAC) procedure, and SCell suspension may be a physical layer procedure.

SCell release may refer to causing the terminal device 100 to discard its configuration for the SCell. As will be appreciated, the network may configure the terminal device to use the released SCell again at a later time (e.g. via an RRC reconfiguration message). SCell deactivation may refer to deactivating the configuration corresponding to the SCell at the terminal device 100, but not discarding it altogether as in the case of a release. After a deactivation, the SCell configuration is retained and may be reactivated with an activation command received from the network (e.g. via a MAC control element, MAC-CE). SCell suspension may refer to the SCell being made dormant by activating a pre-configured ‘dormant bandwidth part (BWP)’ of the SCell. At any given time, there is exactly one active BWP in a cell. As such, if the active BWP of a cell is the dormant BWP then that cell may be regarded as dormant. A reactivation may be implemented with a DL Channel Information (DCI) message on PDCCH via the PCell. However, in some examples, rather than being initiated based on RRC, MAC-CE or DCI signalling, the release, suspend or deactivation procedure may be autonomously triggered for a given SCell when a criterion is met for the SCell.

FIG. 2 is a message flow sequence, indicated generally by the reference numeral 2, in accordance with some aspects of the described technology. The message flow sequence 2 shows an example implementation within which aspects of a process, such as that described with reference to FIG. 1, may be performed. In this example, a terminal device 100 is shown in communication with cells 110, 120 and 130.

It will be appreciated that various operations and entities described with reference to FIG. 2 may correspond to operations and entities described with reference to the preceding Fig. For instance, the terminal device and cells described with reference to FIG. 2 may correspond to those described with reference to FIG. 1.

It will be further appreciated that that various operations described with reference to FIG. 2 may be performed by entities other than those expressly depicted. For instance, some or all of the operations attributed to the terminal device may be performed by another terminal device. Similarly, various operations attributed to cells 110, 120 and 130 may be performed by other network entities, such as a core network (CN) entity, a Radio Access Node, a gNB, or a base station associated with the cell.

In operation 201, an RRC connection is established between terminal device 100 and first cell 110, with the terminal device 100 being configured to use the first cell 110 as a PCell.

In operation 202, the first cell 110, which is acting as the PCell for the terminal device, determines to configure one or more SCells for use in carrier aggregation. For instance, the PCell, or a gNB associated with the PCell, may determine that it is necessary to configure the terminal device 100 for carrier aggregation when the amount of data in its DL buffer is larger than a preconfigured threshold. Having determined that carrier aggregation is to be used, the PCell/gNB may then identify a number of candidate SCells to be configured for use by the terminal device 100. In some examples, candidate SCells are identified based on capabilities of the terminal device 100. In addition or alternatively, candidate SCells may be identified based on the capabilities, current capacity or load of each of the cells under consideration. In some embodiments the candidate SCells could be determined by the gNB based on prioritizing the SCells which have the highest number of combinations supported with the PCell. Supported carrier aggregation combinations and their bandwidths are typically specified and in addition need to be supported by the terminal devices. Furthermore, terminal devices are limited in the number of cells they can employ for carrier aggregation. Determining the minimum set of cells which provides the best performance and/or robustness and/or mobility could be done on the basis of prioritizing SCells which may be swapped with the PCell or between themselves.

In operation 203, the first cell 110 identifies one or more candidate PCells from the one or more SCells determined to be used by the terminal device 100 for carrier aggregation. As will be appreciated, not all SCells may be suitable for use as PCells by the terminal device 100. For instance, a given cell (e.g. a supplementary DL cell) may be capable of functioning as an SCell, but may lack UL capability and so be unable to operate as a PCell for the terminal device 100. On the other hand, a given cell may not be suitable for use as a PCell for the terminal device 100 due to intermodulation distortion. In the example of FIG. 2, at least the second cell 120 is identified as a candidate PCell.

Put another way, a subset of the SCells configured (or to be configured) for use by the terminal device 100 may be considered as candidate PCells for the terminal device 100, which could serve as the target of a PCell swap procedure from the first cell 110 that is autonomously executed by the terminal device 100. In some examples, the candidate PCell(s) may be associated with certain network services or radio conditions. For instance, if it is determined that terminal device 100 is likely or expected to encounter certain radio conditions or request certain network services, SCells with capabilities more suited to such conditions/services may be prioritised for inclusion in the set of candidate PCells.

In operation 204, configuration information is transmitted to the terminal device 100 for use in configuring the terminal device 100 to autonomously execute a PCell swap procedure. As described above with reference to FIG. 1, the configuration information is indicative of (i.e. includes) a post-swap SCell configuration for the first cell 110 (i.e. the current PCell), and post-swap PCell configurations for each of the SCells determined to be candidate PCells in operation 203. For instance, if the second cell 120 is determined to be a candidate PCell, a post-swap PCell configuration for the second cell 120 is indicated by the configuration information.

As described above with reference to FIG. 1, the post-swap PCell configuration(s) comprise respective configurations for the SCells designated as candidate PCells to use in the event that the swap is executed to that cell. Of course, it will be appreciated that, in some examples, only a single candidate PCell and corresponding PCell configuration may be indicated by the configuration information.

Again, as described above with reference to FIG. 1, the post-swap SCell configuration for the current PCell comprises a configuration for the pre-swap PCell to use after the swap is executed. In some examples, the SCell configuration may provide the PDCCH monitoring, BWP configuration, etc, for when the current PCell changes its role to an SCell, a suspension of a PUCCH configuration, a mobility measurement configuration, a radio link monitoring configuration, and/or a random access configuration.

In addition to the post-swap configurations for the PCell and SCell(s), the configuration information received at the terminal device 100 is indicative of at least one triggering condition for autonomous execution by the terminal device 100 of a PCell swap procedure from the first cell 110 to a candidate PCell. In examples in which multiple candidate PCells are identified, at least one triggering condition corresponding to each of the candidate PCells may be indicated by the configuration information. Various examples of triggering conditions for the PCell-SCell swap are described above with reference to FIG. 1.

In summary, the configuration information transmitted in operation 204 amounts to a conditional configuration for PCell-SCell swapping, that may be autonomously triggered/executed by the terminal device 100 based on the at least one triggering condition.

As described above with reference to FIG. 1, the configuration information may be further indicative of a priority for the configured cells when a PCell to SCell swap is triggered based on the triggering condition. In addition or alternatively, and also as described above with reference to FIG. 1, a criterion for releasing the PCell-SCell swap configuration may be included in the configuration information.

In operation 205, the terminal device 100 operates using the first cell 110 as a PCell and the second cell 120 and third cell 130 as SCells. The terminal device 100 is configured with the PCell swap configuration indicated by the received information and may begin to monitor the triggering conditions.

In examples in which the CA configuration is received along with the PCell swap configuration (i.e. when one or more pre-swap SCell configurations, e.g. for cells 120 and 130, are included in the configuration information), the terminal device 100 is configured for CA at this point. As described above with reference to FIG. 1, the CA configuration may, in other examples, be received separately from the PCell swap configuration.

In operation 206, the terminal device 100 determines whether any of the triggering conditions indicted by the PCell swap configuration are met. Put another way, the terminal device 100 monitors the triggering conditions for each of the candidate PCells to determine whether they are satisfied. For instance, a service-based condition may be determined to be met when the terminal device 100 receives a request from its upper layers to initiate a voice call. In this example, the PCell swap configuration may indicate that voice calls are preferred to be handled by the second cell 120 (e.g. based on the capabilities of that cell) and so, responsive to a voice call being initiated, a swap to the second cell 120 should be initiated.

In operation 207, responsive to determining that a triggering condition corresponding to the second cell 120 is met, the PCell swap procedure is autonomously executed by the terminal device 100 from the first cell 110 to the second cell 120. In particular, the terminal device 100 is configured to use the first cell 110 as an SCell, and the second cell 120 as a PCell.

In operation 208, as part of the PCell swap procedure, the terminal device 100 initiates a random access procedure with the second cell 120. This may be a contention-free or contention-based random-access procedure, for instance depending on the received configuration information (in particular the SCell configuration for the second cell 120).

In operation 209, responsive to receiving an indication that the terminal device 100 has autonomously executed the PCell swap procedure to the second cell 120, the second cell 120 activates its configuration to act as a PCell. For instance, the second cell 120 may determine based on that random access preamble used in operation 208 that a PCell swap to the second cell 120 is requested. For instance, this may be determined based on a cell radio network temporary identifier (C-RNTI) used by the terminal device 100 during the random access procedure. In some examples in which the configuration for the PCell swap procedure indicates that there is no need for a random access procedure, for example, due to second cell 120 having the same uplink time alignment as the first cell 110, the terminal device 100 could be configured with a scheduling request resource and/or an additionally-configured C-RNTI to be used in the second cell 120 to indicate the execution of a PCell swap procedure. In this scenario, when the terminal device 100 is not configured for uplink CA, it may employ the second cell configured scheduling request to indicate the triggering of the PCell swap. If the terminal device 100 is configured with uplink CA for the second cell, it may perform a scheduling request and then employ the additionally configured C-RNTI for an uplink transmission to indicate the execution of the PCell swap.

In operation 210, the second cell 120 transmits to the first cell 110, an indication that the PCell swap procedure from the first cell 110 to the second cell 120 has been autonomously executed by the terminal device 100. In operation 212, which may occur before, after or simultaneously with operation 210, the second cell 120 transmits to the third cell 130, an indication that the PCell swap procedure from the first cell 110 to the second cell 120 has been autonomously executed by the terminal device 100. Put another way, in operations 210 and 212, the terminal device 100 notifies other cells within the network of the autonomous PCell swap. It will be appreciated that, in some examples, more or fewer cells may be notified.

In operation 211, responsive to being notified in operation 210, the first cell 110 activates its SCell configuration in accordance with the PCell swap procedure.

In operation 213, responsive to being notified in operation 212, the third cell 130 activates its SCell configuration in accordance with the PCell swap procedure. For instance, the third cell 130 may activate any specific SCell configuration for use when the second cell 120 is acting as a PCell. As will be appreciated, the terminal device procedure for monitoring PDCCH has a dependency on the SCells and their subcarrier spacing (SCS), and so PDCCH scheduling aspects may need to be reconfigured. Additionally, the third cell 130 may not support CA combinations in which the second cell 120 is a PCell, and so may need to be deactivated as an SCell.

As mentioned above with reference to FIG. 1, after a PCell swap, data does not need to be forwarded between the cells. Each cell with data in the DL buffer may continue to handle the scheduling of its allocated data, however some retransmissions may be required due to terminal device interruption when performing, for example, the random access procedure.

In operation 214, the terminal device 100 operates using the second cell 120 as a PCell and the first cell 110 and third cell 130 as SCells.

In some examples, if the timing difference between the PCell being swapped from and the SCell being swapped to (i.e. the target of the PCell swap) is small (e.g. below a threshold), if the cells are synchronized, or the SCell being swapped to is already an active uplink SCell with established link timing, then the random access procedure (i.e. operation 208) is not required to be performed. Instead, the serving PCell may be notified of the terminal device's intention to trigger a PCell swap based on a terminal device report such as CQI or a transmission on a certain bearer (e.g. QCI 5 for IP Multimedia Subsystem (IMS) signalling to setup a voice call). In this case, the terminal device would trigger the PCell-SCell swap after the established action.

When the triggering condition is based on a need for the terminal device 100 to establish a specific type of bearer that is not prioritized in the current PCell (e.g. service-based triggering conditions as described above), admission control may not be not required for these ‘high priority’ service types since they would already cause a degradation in other ‘best effort’ traffic. If admission control is required, then service-based triggering conditions could be excluded as a PCell-SCell swap criterion, with existing mobility or load balancing techniques used to maintain the required levels of coverage and bandwidth for execution of the service.

The PCell-SCell swap procedure described above is also applicable to UL CA. In this case, the terminal device 100 could, for instance, trigger a PCell swap if it is power limited (e.g. based on PUCCH or PUSCH transmit power) in order to attain a more robust PUCCH with a new target cell.

As will be appreciated, the framework described above differs from conventional conditional handover (CHO) procedures at least in that the PCell swap configuration defines an SCell configuration for the initial PCell (e.g. the first cell 110) to be used post-swap. The configuration allows the terminal device to know the parametrization of the PCell when it will act as an SCell after a swap. Moreover, conventional criteria for triggering CHO are limited to measurements. As described above, various other triggers are possible within the present framework, such as service-based triggers. Moreover, in some examples, the configuration is pervasive, meaning that additional PCell-SCell swaps can be performed without further configuration. Finally, and as mentioned above, employment of the presently described procedure obviates the need for indication of status transfer or forwarding data.

FIG. 3 is a flowchart depicting various operations which may be performed in accordance with various examples. For instance, the operations depicted in FIG. 3 may be executed by a terminal device or other suitable apparatus.

In operation S3.1, the terminal device is configured to use a first cell of a telecommunication network as a primary cell, PCell, based on a PCell configuration for the first cell, and to use a second cell of the telecommunication network as a secondary cell, SCell, based on an SCell configuration for the second cell. In some examples, the terminal device is configured to use a plurality of cells of the telecommunication network as SCells based on a plurality of SCell configurations for the respective plurality of cells, the plurality of cells including the second cell.

In operation S3.2, the terminal device receives configuration information indicative of: a post-swap PCell configuration for the second cell, a post-swap SCell configuration for the first cell, and at least one triggering condition for autonomous execution by the terminal device of a PCell swap procedure from the first cell to the second cell. The at least one triggering condition may comprise at least one of the following: at least one measurement of signals received from the first cell being below a threshold; at least one measurement of signals received from the second cell being above a threshold; at least one measurement of signals received from the second cell being offset better than at least one measurement of signals received from the first cell; a transmit power for an uplink transmission from the terminal device to the first cell being above a transmit power threshold; or initiation, by the terminal device, of a particular service or service type. In some examples, the at least one measurement of signals received from the first cell and the at least one measurement of signals received from the second cell comprise reference signal received power, RSRP, measurements or reference signal received quality, RSRQ, measurements. However, as described above with reference to the previous Figs., other types of measurement may be used (e.g. received signal strength indicator, RSSI, measurements). In addition or alternatively, the post-swap SCell configuration for the first cell and the post-swap PCell configuration for the second cell indicated by the received configuration information may comprise at least one of the following: a Physical Downlink Control Channel, PDCCH, monitoring configuration; a Physical Uplink Control Channel, PUCCH, transmit configuration; a measurement configuration for mobility measurements; a radio link monitoring configuration; a random-access configuration; a scheduling request configuration; or an uplink timing offset with respect to another cell of the telecommunication network.

In examples in which the terminal device is configured, at operation S3.1, to use a plurality of cells as SCells, the received configuration information may be further indicative of: a plurality of post-swap PCell configurations for the respective plurality of cells, and a plurality of triggering conditions for autonomous execution by the terminal device of PCell swap procedures from the first cell to the respective plurality of cells. In some such examples, the received configuration information may be further indicative of priorities for the respective plurality of cells to be selected as a target PCell for autonomous execution by the terminal device of a PCell swap procedure from the first cell.

In operation S3.3, the terminal device determines that a triggering condition of the at least one triggering condition is met. In some examples, the trigging condition is met after the receipt of the configuration information in operation S3.2. In other examples, the triggering condition is met before the receipt of the configuration information.

In operation S3.4, responsive to the determination, in operation S3.3, that the triggering condition is met, the terminal device executes the PCell swap procedure from the first cell to the second cell by: configuring the terminal device to use the second cell as a PCell based on the post-swap PCell configuration for the second cell, and configuring the terminal device to use the first cell as an SCell based on the post-swap SCell configuration for the first cell. For instance, responsive to the terminal device being configured to use the second cell as a PCell, the terminal device may perform a random access procedure to the second cell. In addition or alternatively, the terminal device may transmit a scheduling request to the second cell, or may transmit an additionally-configured C-RNTI to the second cell.

In some examples, after executing the PCell swap procedure from the first cell to the second cell, the terminal device is configured to maintain the PCell configuration for the first cell and the SCell configuration for the second cell. In this case, responsive to a further triggering condition being met, the terminal device may execute a further PCell swap procedure from the second cell back to the first cell by: configuring the terminal device to use the first cell as a PCell based on the maintained PCell configuration for the first cell, and configuring the terminal device to use the second cell as an SCell based on the maintained SCell configuration for the second cell.

In examples in which the received configuration information is indicative of a plurality of triggering conditions, operation S3.3 may comprise determining that a particular triggering condition of the plurality of triggering conditions is met, while operation S3.4 may comprise, responsive to the determination that the particular triggering condition is met, executing a PCell swap procedure from the first cell to a particular cell of the plurality of cells which corresponds to the particular triggering condition by: configuring the terminal device to use the particular cell as a PCell based on a particular post-swap PCell configuration for the particular cell, the particular post-swap PCell configuration being part of the plurality of post-swap PCell configurations, and configuring the terminal device to use the first cell as an SCell based on the post-swap SCell configuration for the first cell.

In some examples, the received configuration information is further indicative of a release condition for autonomous execution by the terminal device of the PCell swap procedure from the first cell to the second cell. In such examples, the method may further include operations S3.5a and S3.6a.

In operation S3.5a, the terminal device determines that the release condition indicated by the received information is met.

In operation S3.6a, responsive to the determination (at operation S3.5a) that the release condition is met, the terminal device discards the received configuration information for autonomous execution by the terminal device of the PCell swap procedure from the first cell to the second cell.

In addition or alternatively, the received configuration information may be further indicative of an SCell release, suspension or deactivation condition for autonomous execution by the terminal device of an SCell release, suspension or deactivation procedure. In such examples, the method may further include operations S3.5b and S3.6b.

In operation S3.5b, the terminal device determines that the SCell release, suspension or deactivation condition is met for a cell, which the terminal device is configured to use as an SCell.

In operation S3.6b, responsive to the determination that the SCell release, suspension or deactivation condition is met for the cell, the terminal device is configured to autonomously release, suspend or deactivate the cell.

As will of course be appreciated, various operations illustrated in FIG. 3 may correspond to operations already described with reference to the preceding Figs. For instance, operation S3.2 may correspond to operation 204 of FIG. 2, operation S3.3 may correspond to operation 206 of FIG. 2, and operation S3.4 may correspond to operation 207 in FIG. 2.

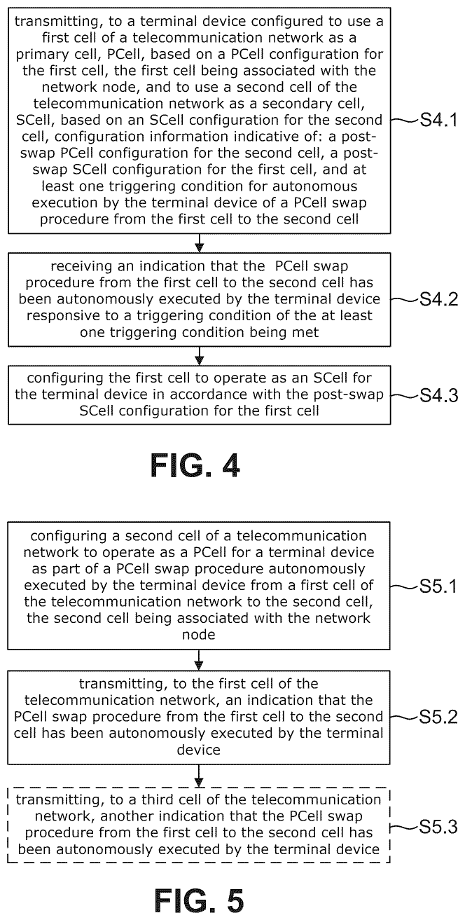

FIG. 4 is a flowchart depicting various operations which may be performed in accordance with various examples. For instance, the operations depicted in FIG. 4 may be executed by a base station or other suitable apparatus.

In operation S4.1, configuration information is transmitted to a terminal device configured to use a first cell of a telecommunication network as a PCell based on a PCell configuration for the first cell, and to use a second cell of the telecommunication network as an SCell based on an SCell configuration for the second cell. The configuration information is indicative of: a post-swap PCell configuration for the second cell, a post-swap SCell configuration for the first cell, and at least one triggering condition for autonomous execution by the terminal device of a PCell swap procedure from the first cell to the second cell.

In operation S4.2, an indication that the PCell swap procedure from the first cell to the second cell has been autonomously executed by the terminal device responsive to a triggering condition of the at least one triggering condition being met is received. In some examples, the indication is received from the second cell subsequent to the second cell being configured to operate as a PCell for the terminal device.

In operation S4.3, the first cell is configured to operate as an SCell for the terminal device in accordance with the post-swap SCell configuration for the first cell. For instance, this may comprise activating one or more network resources indicated by the post-swap SCell configuration for the first cell, and/or de-activating one or more network resources not indicated by the post-swap SCell configuration.

As will of course be appreciated, various operations illustrated in FIG. 4 may correspond to operations already described with reference to the preceding Figs. For instance, operation S4.1 may correspond to operation 204 in FIG. 2, operation S4.2 may correspond to operation 210 in FIG. 2, and operation S4.3 may correspond to operation 211 in FIG. 2.

FIG. 5 is a flowchart depicting various operations which may be performed in accordance with various examples. For instance, the operations depicted in FIG. 4 may be executed by a base station or other suitable apparatus.

In operation S5.1, a second cell of a telecommunication network is configured to operate as a PCell for a terminal device as part of a PCell swap procedure autonomously executed by the terminal device from a first cell of the telecommunication network to the second cell. For instance, the second cell may be configured to operate as the PCell for the terminal device as part of the PCell swap procedure responsive to the detection of a random access procedure initiated by the terminal device with the second cell. In addition or alternatively, the second cell may be configured to operate as the PCell for the terminal device as part of the PCell swap procedure responsive to the detection of a scheduling request received from the terminal device; or the detection of an uplink transmission from the terminal device using an additionally-configured Cell Radio Network temporary Identifier, C-RNTI.

In operation S5.2, an indication that the PCell swap procedure from the first cell to the second cell has been autonomously executed by the terminal device is transmitted to the first cell of the telecommunication network.

In some examples, the method includes operation S5.3, in which an indication that the PCell swap procedure from the first cell to the second cell has been autonomously executed by the terminal device is transmitted to a third cell of the telecommunication network.

As will of course be appreciated, various operations illustrated in FIG. 5 may correspond to operations already described with reference to the preceding Figs. For instance, operation S5.1 may correspond to operation 209 of FIG. 2, operation S5.2 may correspond to operation 210 of FIG. 2, and operation S5.3 may correspond to operation 212 of FIG. 2.

FIG. 6 is a schematic illustration of an example configuration of a terminal device 6 which may be configured to perform various operations described with reference to FIGS. 1 to 5.

The terminal device 6 may comprise control apparatus 600 which is configured to control operation of other components which form part of the terminal device 6 thereby to enable performance of various operations described with reference to FIGS. 1 to 5. The computing apparatus 600 may comprise processing apparatus 601 and memory 602. Computer-readable code 602-2A may be stored on the memory 602, which when executed by the processing apparatus 601, causes the control apparatus 600 to perform any of the operations described herein.

In addition, the terminal device 6 may further include a display 603, user interactive interface (UII) 604, radio frequency interface 605 configured to interface radio frequency signals transmitted and received via a radio frequency antenna array 605A, and global navigation satellite system (GNSS) 606. In some examples, other satellite communications systems may be used instead of or in addition to GNSS 606. Although the terminal device 6 in FIG. 6 is shown as having an array 605A of four antennas, this is illustrative only. The number of antennas may vary, for instance, from one to many hundreds.

FIG. 7 is a schematic illustration of an example configuration of a base station 7 which may be configured to perform various operations described with reference to FIGS. 1 to 5.

The base station 7, which may be referred to an eNB, gNB or access point (AP), comprises control apparatus 700 which is configured to control operation of other components which form part of the base station 7 thereby to enable transmission of signals to and receipt of signals from UEs in its coverage area vicinity. For example, the base station control apparatus 700 is configured to cause transmission of reference signals to UEs within its coverage area. Furthermore, in some examples, the control apparatus 700 may be configured to enable receipt of reference signal measurement data and/or location data from the UEs in its coverage area. The control apparatus 700 may also enable communication with other base stations and/or other network nodes. The control apparatus 700 may additionally be configured to cause performance of any other operations described herein with reference to the base station 7.

The base station 7 comprises a radio frequency antenna array 705 configured to receive and transmit radio frequency signals. Although the base station 7 in FIG. 7 is shown as having an array 705A of four antennas, this is illustrative only. The number of antennas may vary, for instance, from one to many hundreds.

The base station 7 further comprises a radio frequency interface 705 configured to interface the radio frequency signals received and transmitted by the antenna 705A and a control apparatus 700. The radio frequency interface 705 may also be known as a transmitter, receiver and/or transceiver. The base station 7 may also comprise an interface 707 via which, for example, it can communicate with other network elements such as other radio access network entities (such as the other base stations) and/or core network entities.

The base station control apparatus 700 may be configured to process signals from the radio frequency interface 705, to control the radio frequency interface 705 to generate suitable RF signals to communicate information to UEs via the wireless communications link, and also to exchange information with other base stations and core network entities via the interface 707.

The control apparatus 700 may comprise processing apparatus 701 and memory 702. Computer-readable code 702-2A may be stored on the memory 702, which when executed by the processing apparatus 701, causes the control apparatus 700 to perform any of the operations described herein and attributed to the base station 7.

Some further details of components and features of the above-described devices/entities/apparatuses 6, 7 and alternatives for them will now be described.

The control apparatuses described above 600, 700 may comprise processing apparatus 601, 701 communicatively coupled with memory 602, 702. The memory 602, 702 has computer readable instructions 602-2A, 702-2A stored thereon, which when executed by the processing apparatus 601, 701 causes the control apparatus 600, 700 to cause performance of various ones of the operations described with reference to FIGS. 1 to 5. The control apparatus 600, 700 may in some instance be referred to, in general terms, as “apparatus”.

The processing apparatus 601, 701 may be of any suitable composition and may include one or more processors 601A, 701A of any suitable type or suitable combination of types. Indeed, the term “processing apparatus” should be understood to encompass computers having differing architectures such as single/multi-processor architectures and sequencers/parallel architectures. For example, the processing apparatus 601, 701 may be a programmable processor that interprets computer program instructions 602-2A, 702-2A and processes data. The processing apparatus 601, 701 may include plural programmable processors. Alternatively, the processing apparatus 601, 701 may be, for example, programmable hardware with embedded firmware. The processing apparatus 601, 701 may alternatively or additionally include one or more specialised circuit such as field programmable gate arrays FPGA, Application Specific Integrated Circuits (ASICs), signal processing devices etc. In some instances, processing apparatus 601, 701 may be referred to as computing apparatus or processing means.

The processing apparatus 601, 701 is coupled to the memory 602, 702 and is operable to read/write data to/from the memory 602, 702. The memory 602, 702 may comprise a single memory unit or a plurality of memory units, upon which the computer readable instructions (or code) 602-2A, 702-2A is stored. For example, the memory 602, 702 may comprise both volatile memory 602-1, 702-1 and non-volatile memory 602-2, 702-2. In such examples, the computer readable instructions/program code 602-2A, 702-2A may be stored in the non-volatile memory 602-2, 702-2 and may be executed by the processing apparatus 601, 701 using the volatile memory 602-1, 702-1 for temporary storage of data or data and instructions. Examples of volatile memory include random-access memory (RAM), dynamic random-access memory (DRAM), and synchronous dynamic random-access memory (SDRAM) etc. Examples of non-volatile memory include read-only memory (ROM), programmable read-only memory (PROM), electronically erasable programmable read-only memory (EEPROM), flash memory, optical storage, magnetic storage, etc.

The memory 602, 702 may be referred to as one or more non-transitory computer readable memory medium or one or more storage devices. Further, the term ‘memory’, in addition to covering memory comprising both one or more non-volatile memory and one or more volatile memory, may also cover one or more volatile memories only, one or more non-volatile memories only. In the context of this document, a “memory” or “computer-readable medium” may be any media or means that can contain, store, communicate, propagate or transport the instructions for use by or in connection with an instruction execution system, apparatus, or device, such as a computer.

The computer readable instructions/program code 602-2A, 702-2A may be pre-programmed into the control apparatus 600, 700. Alternatively, the computer readable instructions 602-2A, 702-2A may arrive at the control apparatus via an electromagnetic carrier signal or may be copied from a physical entity 8 such as a computer program product, a memory device or a record medium such as a compact disc read-only memory (CD-ROM) or digital versatile disc (DVD) an example of which is illustrated in FIG. 8. The computer readable instructions 602-2A, 702-2A may provide the logic and routines that enables the entities devices/apparatuses 6, 7 to perform the functionality described above. The combination of computer-readable instructions stored on memory (of any of the types described above) may be referred to as a computer program product. In general, references to computer program, instructions, code etc. should be understood to express software for a programmable processor firmware such as the programmable content of a hardware device as instructions for a processor or configured or configuration settings for a fixed function device, gate array, programmable logic device, etc.

If desired, the different functions discussed herein may be performed in a different order and/or concurrently with each other. Furthermore, if desired, one or more of the above-described functions may be optional or may be combined. Similarly, it will also be appreciated that the flow diagrams of FIGS. 2 to 5 are examples only and that various operations depicted therein may be omitted, reordered and/or combined.

Although the methods and apparatuses have been described in connection with an E-UTRA or NG network, it will be appreciated that they are not limited to such networks and are applicable to radio networks of various different types.

Although various aspects of the methods and apparatuses described herein are set out in the independent claims, other aspects may comprise other combinations of features from the described embodiments and/or the dependent claims with the features of the independent claims, and not solely the combinations explicitly set out in the claims.

It is also noted herein that while various examples are described above, these descriptions should not be viewed in a limiting sense. Rather, there are several variations and modifications which may be made without departing from the scope of the present invention as defined in the appended claims.

1. An apparatus comprising at least one processor, and at least one memory storing instructions that, when executed by the at least one processor, cause the apparatus at least to perform:
configuring the apparatus to use a first cell of a telecommunication network as a primary cell (PCell) based on a PCell configuration for the first cell, and to use a second cell of the telecommunication network as a secondary cell (SCell) based on an SCell configuration for the second cell;
receiving configuration information indicative of:
a post-swap PCell configuration for the second cell,
a post-swap SCell configuration for the first cell, and
at least one triggering condition for autonomous execution by the apparatus of a PCell swap procedure from the first cell to the second cell;
determining that a triggering condition of the at least one triggering condition is met; and
responsive to the determination that the triggering condition is met, executing the PCell swap procedure from the first cell to the second cell by:
configuring the apparatus to use the second cell as a PCell based on the post-swap PCell configuration for the second cell, and
configuring the apparatus to use the first cell as an SCell based on the post-swap SCell configuration for the first cell.

2. The apparatus of claim 1, wherein the post-swap PCell configuration for the second cell and the post-swap SCell configuration for the first cell are received prior to the triggering condition being met.

3. The apparatus of claim 1, wherein the at least one triggering condition comprises at least one of the following:
at least one measurement of signals received from the first cell being below a threshold;
at least one measurement of signals received from the second cell being above a threshold;
at least one measurement of signals received from the second cell being offset better than at least one measurement of signals received from the first cell;
a transmit power for an uplink transmission from the apparatus to the first cell being above a transmit power threshold; or
initiation, by the apparatus, of a particular service or service type.

4. The apparatus of claim 3, wherein the at least one measurement of signals received from the first cell and the at least one measurement of signals received from the second cell comprise reference signal received power measurements or reference signal received quality measurements.

5. The apparatus of claim 1, wherein the instructions stored on the at least one memory, when executed by the at least one processor, further cause the apparatus at least to perform:
configuring the apparatus to use a plurality of cells of the telecommunication network as SCells based on a plurality of SCell configurations for the respective plurality of cells, the plurality of cells including the second cell,
wherein the received configuration information is further indicative of:
a plurality of post-swap PCell configurations for the respective plurality of cells, and
a plurality of triggering conditions for autonomous execution by the apparatus of PCell swap procedures from the first cell to the respective plurality of cells,
determining that a particular triggering condition of the plurality of triggering conditions is met; and
responsive to the determination that the particular triggering condition is met, executing a PCell swap procedure from the first cell to a particular cell of the plurality of cells which corresponds to the particular triggering condition by:
configuring the apparatus to use the particular cell as a PCell based on a particular post-swap PCell configuration for the particular cell, the particular post-swap PCell configuration being part of the plurality of post-swap PCell configurations, and
configuring the apparatus to use the first cell as an SCell based on the post-swap SCell configuration for the first cell.

6. The apparatus of claim 5, wherein the received configuration information is further indicative of priorities for the respective plurality of cells to be selected as a target PCell for autonomous execution by the apparatus of a PCell swap procedure from the first cell.

7. The apparatus of claim 1, wherein the post-swap SCell configuration for the first cell and the post-swap PCell configuration for the second cell comprise at least one of the following:
a Physical Downlink Control Channel monitoring configuration;
a Physical Uplink Control Channel transmit configuration;
a measurement configuration for mobility measurements;
a radio link monitoring configuration;
a random-access configuration;
a scheduling request configuration; or
an uplink timing offset with respect to another cell of the telecommunication network.

8. The apparatus of claim 1, wherein the instructions stored on the at least one memory, when executed by the at least one processor, further cause the apparatus at least to perform:
maintaining, after executing the PCell swap procedure from the first cell to the second cell, the PCell configuration for the first cell and the SCell configuration for the second cell; and
responsive to a further triggering condition being met, executing a further PCell swap procedure from the second cell back to the first cell by:
configuring the apparatus to use the first cell as a PCell based on the maintained PCell configuration for the first cell, and
configuring the apparatus to use the second cell as an SCell based on the maintained SCell configuration for the second cell.

9. The apparatus of claim 1, wherein the received configuration information is further indicative of a release condition for autonomous execution by the apparatus of the PCell swap procedure from the first cell to the second cell,
and wherein the instructions stored on the at least one memory, when executed by the at least one processor, further cause the apparatus at least to perform:
determining that the release condition is met; and
responsive to the determination that the release condition is met, discarding the received configuration information for autonomous execution by the apparatus of the PCell swap procedure from the first cell to the second cell.

10. The apparatus of claim 1, wherein the instructions stored on the at least one memory, when executed by the at least one processor, further cause the apparatus at least to perform:
responsive to the apparatus being configured to use the second cell as a PCell, performing one of the following:
performing a random access procedure to the second cell;
transmitting a scheduling request to the second cell; or
transmitting an additionally-configured Cell Radio Network temporary Identifier to the second cell.

11. The apparatus of claim 1, wherein the received configuration information is further indicative of an SCell release, suspension or deactivation condition for autonomous execution by the apparatus of an SCell release, suspension or deactivation procedure,
and wherein the instructions stored on the at least one memory, when executed by the at least one processor, further cause the apparatus at least to perform:
determining that the SCell release, suspension or deactivation condition is met for a cell, which the apparatus is configured to use as an SCell; and
responsive to the determination that the SCell release, suspension or deactivation condition is met for the cell, configuring the apparatus to release, suspend or deactivate the cell.

12. An apparatus comprising at least one processor, and at least one memory storing instructions that, when executed by the at least one processor, cause the apparatus at least to perform:
transmitting, to a terminal device configured to use a first cell of a telecommunication network as a primary cell (PCell) based on a PCell configuration for the first cell, the first cell being associated with the apparatus, and to use a second cell of the telecommunication network as a secondary cell (SCell) based on an SCell configuration for the second cell, configuration information indicative of:
a post-swap PCell configuration for the second cell,
a post-swap SCell configuration for the first cell, and
at least one triggering condition for autonomous execution by the terminal device of a PCell swap procedure from the first cell to the second cell;
receiving an indication that the PCell swap procedure from the first cell to the second cell has been autonomously executed by the terminal device responsive to a triggering condition of the at least one triggering condition being met; and
configuring the first cell to operate as an SCell for the terminal device in accordance with the post-swap SCell configuration for the first cell.

13. The apparatus of claim 12, wherein the post-swap SCell configuration for the first cell and the post-swap PCell configuration for the second cell comprise at least one of the following:
a Physical Downlink Control Channel monitoring configuration;
a Physical Uplink Control Channel transmit configuration;
a measurement configuration for mobility measurements;
a radio link monitoring configuration;
a random-access configuration;
a scheduling request configuration; or
an uplink timing offset with respect to another cell of the telecommunication network.

14. The apparatus of claim 12, wherein configuring the first cell to operate as an SCell for the terminal device in accordance with the post-swap SCell configuration for the first cell comprises activating one or more network resources indicated by the post-swap SCell configuration for the first cell.

15. The apparatus of claim 12, wherein the indication is received from the second cell subsequent to the second cell being configured to operate as a PCell for the terminal device.

16. An apparatus comprising at least one processor and at least one memory storing instructions that, when executed by the at least one processor, cause the apparatus at least to perform:
configuring a second cell of a telecommunication network to operate as a primary cell (PCell) for a terminal device as part of a PCell swap procedure autonomously executed by the terminal device from a first cell of the telecommunication network to the second cell, the second cell being associated with the apparatus; and
transmitting, to the first cell of the telecommunication network, an indication that the PCell swap procedure from the first cell to the second cell has been autonomously executed by the terminal device.

17. The apparatus of claim 16, wherein the instructions stored on the at least one memory, when executed by the at least one processor, further cause the apparatus at least to perform:
transmitting, to a third cell of the telecommunication network, another indication that the PCell swap procedure from the first cell to the second cell has been autonomously executed by the terminal device.

18. The apparatus of claim 16, wherein the second cell is configured to operate as a PCell for the terminal device as part of the PCell swap procedure responsive to the detection of one of:
a random access procedure initiated by the terminal device with the second cell;
a scheduling request received from the terminal device; or
an additionally-configured Cell Radio Network temporary Identifier received from the terminal device.
